(19) United States
(12) Patent Application Publication
(10) Pub. No.: US 2026/0140286 A1
(43) Pub. Date: May 21, 2026

(54) LENS MODULE AND ELECTRONIC DEVICE FOR IMPROVING AN IMAGE QUALITY OF THE LENS MODULE

(71) Applicant: Newmax Technology Co., Ltd., Taichung City (TW)

(72) Inventors: Yung-Fu LIANG, Taichung City (TW); Chiung-Hung CHEN, Taichung City (TW)

(21) Appl. No.: 19/094,633

(22) Filed: Mar. 28, 2025

(30) Foreign Application Priority Data
Nov. 21, 2024 (TW) 113144973

(51) Int. Cl. G02B 5/00; G02B 7/02

(52) U.S. Cl. CPC G02B 5/003; G02B 7/021

(57) ABSTRACT

A lens module includes a lens barrel and an optical lens assembly. The lens barrel has a hollow barrel. The optical lens assembly is disposed in the lens barrel. The optical lens assembly includes at least one lens. The hollow barrel includes an inner periphery, and the inner periphery includes first and second cut edges, which are respectively contracted toward the center of the hollow barrel along the Y axis; and in the plan view of the hollow barrel along the central axis, each contour line of the first and second cut edges includes one of the following elements of: an arc line that is convex outward along the Y axis, an arc line that is concave inward along the Y axis, two oblique lines that are connected and convex outward along the Y axis, and two oblique lines that are connected and concave inward along the Y axis.

This application claims the benefit of Taiwan Patent Application No. 113144973, filed on November 21, 2024, which is hereby incorporated by reference for all purposes as if fully set forth herein.

### BACKGROUND

### Technical Field

The present disclosure relates to a lens module, and in particular to an electronic device having a lens module.

### Related Art

The shooting function is already an indispensable function for terminal electronic devices (such as mobile phones, laptops, tablets, etc.). In order to obtain good image quality and camera effects, lens modules are installed in electronic devices to provide an extensive shooting function. Electronic devices emphasize the ratio of screen to body, and the front of a general electronic device not only has the display screen, but also has components such as front lens modules, which affects the ratio of screen to body according to the electronic device.

Currently, lightness, thinness and narrow frame of electronic devices are industry development needs. The lens module is usually disposed on the frame of the display screen of the electronic device. Since the lens module has a certain height and width, when the lens module is disposed on the frame of the display screen of the electronic device, it is difficult for the electronic device to achieve a narrow frame. The narrow frame will also increase the thickness of the electronic device and makes the electronic device difficult to achieve thinness and lightness.

An imaging circle of the lens module is usually larger than the size of the optical sensor, and currently it is a major design trend to contract the lens module in the specific direction to increase the ratio of screen to body. However, when the lens module in the prior art is contracted in the specific direction, additional stray light may be generated.

Thus, a lens module and an electronic device need to be provided for meeting previous requirements.

### SUMMARY

An objective of the present disclosure is to provide a lens barrel of a lens module, which eliminates stray light by designing structural cut edges to improve an image quality of the lens module.

To achieve the above objective, the present disclosure provides a lens module, defining a central axis, an X axis, a Y axis, an object side and an image side, wherein the central axis, the X axis and the Y axis are perpendicular to each other, and the lens module comprises: a lens barrel having a hollow barrel; and an optical lens assembly disposed in the lens barrel, wherein the optical lens assembly includes at least one lens; and wherein the hollow barrel comprises an inner periphery, and the inner periphery comprises first and second cut edges, which are respectively contracted toward a center of the lens along the Y axis; and in a plan view of the hollow barrel along the central axis, each contour line of the first and second cut edges includes one of the following elements of: an arc line that is convex outward along the Y axis, an arc line that is concave inward along the Y axis, two oblique lines that are connected and convex outward along the Y axis, and two oblique lines that are connected and concave inward along the Y axis.

The present disclosure further provides an electronic device, comprising: a housing; the above-mentioned lens module disposed in the housing, and a control component disposed in the housing and electrically connected to an optical sensor of the lens module.

The lens barrel of the lens module of the present disclosure can scatter light by designing structural cut edges (such as an arc line, two oblique lines, a combination of an arc line and a straight line, or a combination of two oblique lines and a straight line), thereby eliminating stray light to improve an image quality of the lens module.

### BRIEF DESCRIPTION OF THE DRAWINGS

FIG. 1 is a schematic sectional view of a lens module according to an embodiment of the present disclosure.

FIG. 2 is a schematic exploded perspective view of a lens module according to an embodiment of the present disclosure.

FIG. 3 is a schematic front view of a lens module according to an embodiment of the present disclosure.

FIG. 4 is a schematic perspective view of a lens of a lens module according to an embodiment of the present disclosure.

FIG. 5a is a schematic rear plan view of a lens barrel of a lens module according to the first embodiment of the present disclosure.

FIG. 5b is a schematic rear plan view of a lens barrel of a lens module according to the second embodiment of the present disclosure.

FIG. 5c is a schematic rear plan view of a lens barrel of a lens module according to the third embodiment of the present disclosure.

FIG. 5d is a schematic rear plan view of a lens barrel of a lens module according to the fourth embodiment of the present disclosure.

FIG. 5e is a schematic rear plan view of a lens barrel of a lens module according to the fifth embodiment of the present disclosure.

FIG. 5f is a schematic rear plan view of a lens barrel of a lens module according to the sixth embodiment of the present disclosure.

FIG. 5g is a schematic rear plan view of a lens barrel of a lens module according to the seventh embodiment of the present disclosure.

FIG. 5h is a schematic rear plan view of a lens barrel of a lens module according to the eighth embodiment of the present disclosure.

FIG. 5i is a schematic rear plan view of a lens barrel of a lens module according to the ninth embodiment of the present disclosure.

FIG. 6 is a schematic rear view of a lens barrel and a lens of a lens module according to an embodiment of the present disclosure.

FIG. 7a is a schematic sectional view of a lens barrel of a lens module according to the tenth embodiment of the present disclosure.

FIG. 7b is a schematic sectional view of a lens barrel of a lens module according to the eleventh embodiment of the present disclosure.

FIG. 8a and FIG. 8b are two schematic sectional views of a lens barrel and lens of a lens module according to an embodiment of the present disclosure.

FIG. 9a is a schematic partial perspective view of a lens barrel of a lens module of the twelfth embodiment of the present disclosure.

FIG. 9b is a schematic partial perspective view of a lens barrel of a lens module of the thirteenth embodiment of the present disclosure.

FIG. 10a is a schematic partial perspective view of a lens barrel of a lens module of the fourteenth embodiment of the present disclosure.

FIG. 10b is a schematic sectional view of a lens barrel of a lens module of the fourteenth embodiment of the present disclosure.

FIG. 11 is a schematic sectional view of an electronic device according to an embodiment of the present disclosure.

### DETAILED DESCRIPTION

To make the foregoing objectives, characteristics and features of the present disclosure more comprehensible, preferred embodiments of the present disclosure are described in detail below with reference to the accompanying drawings.

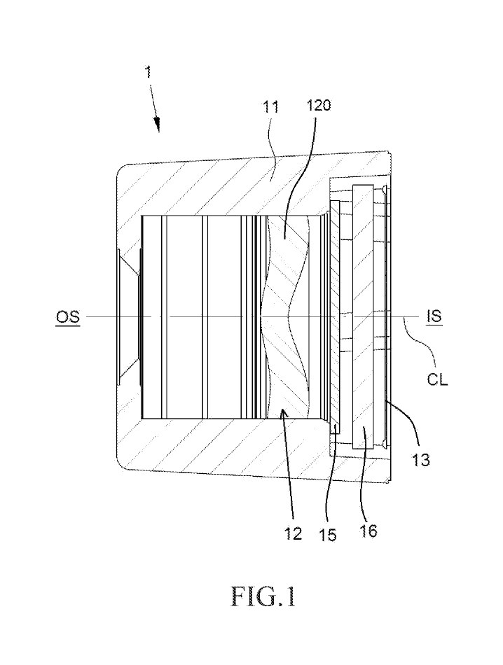

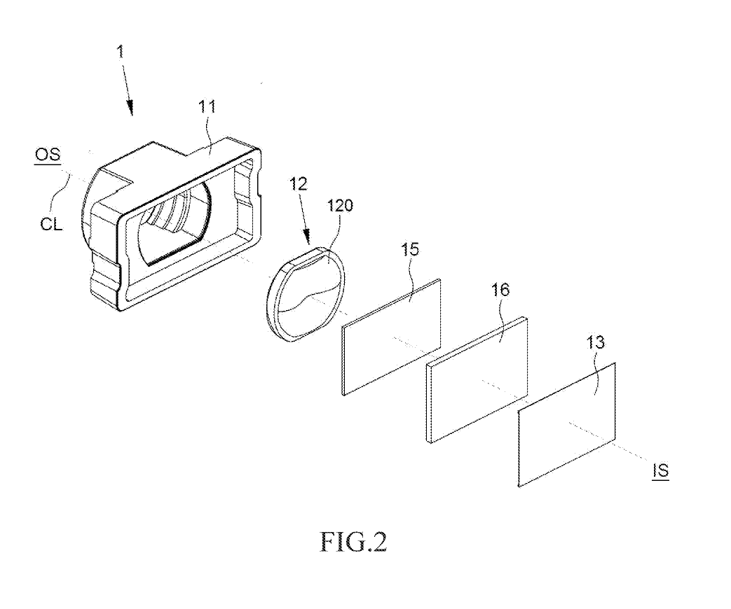

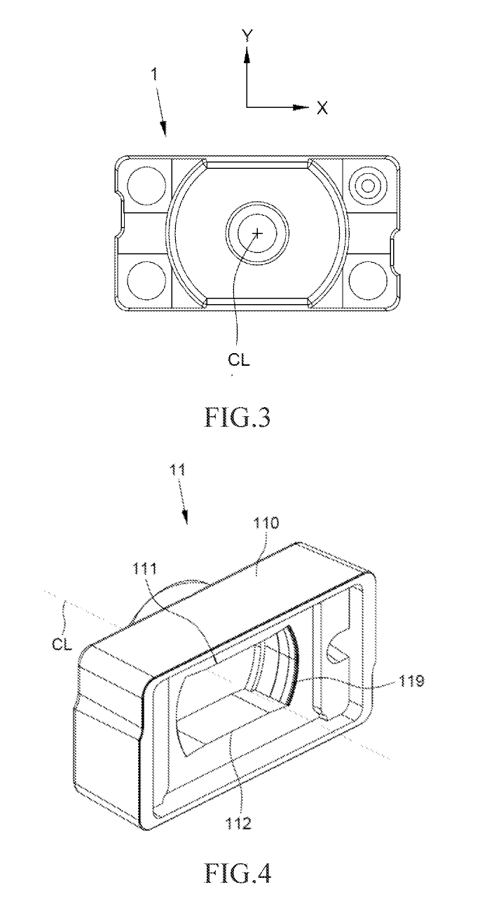

FIG. 1 is a schematic sectional view of a lens module according to an embodiment of the present disclosure. FIG. 2 is a schematic exploded perspective view of a lens module according to an embodiment of the present disclosure. FIG. 3 is a schematic front view of a lens module according to an embodiment of the present disclosure. Referring to FIG. 1, FIG. 2 and FIG. 3, the lens module 1 defines a central axis CL, an X axis, a Y axis, an object side OS and an image side IS. The central axis CL, the X axis, the Y axes are perpendicular to each other, and the image side IS is opposite to the object side OS. The lens module 1 includes: a lens barrel 11, an optical lens assembly 12 and an optical sensor 13.

Refer to FIG. 1 and FIG. 2 again, the optical lens assembly 12 is disposed in the lens barrel 11, wherein the optical lens assembly 12 includes at least one lens 120. For example, the optical lens assembly 12 includes a plurality of lenses 120, such as a first lens to an N-th lens. The N-th lens is the lens of the optical lens assembly 12 that is the closest to the image side IS, and N is an integer greater than zero. The lens module 1 further includes a plurality of optical elements arranged in the lens barrel 11, and the optical elements can be an optical filter (such as an infrared optical filter, an infrared bandpass optical filter, or other optical band filters, etc.), a light-shielding element (for example, an aperture stop or a stop configured to correct edge light), spacers (e.g. as optical spacers between lenses) or the like.

The optical sensor 13 is disposed in the lens barrel 11 and is located on an image plane. The optical sensor 13 may be an image sensor. The lens module 1 further includes: an optical filter 15 and a cover glass 16, which are sequentially disposed between the optical lens assembly 12 and the optical sensor 13.

FIG. 4 is a schematic perspective view of a lens barrel of a lens module according to an embodiment of the present disclosure. Referring to FIG. 4, the lens barrel 11 has a hollow barrel 110. The hollow barrel 110 includes an inner periphery 119. The inner periphery 119 includes a first cut edge 111 and a second cut edge 112, which are respectively contracted toward the center (i.e., the position close to the central axis CL) of the hollow barrel 110 of the lens barrel 11 along the Y axis.

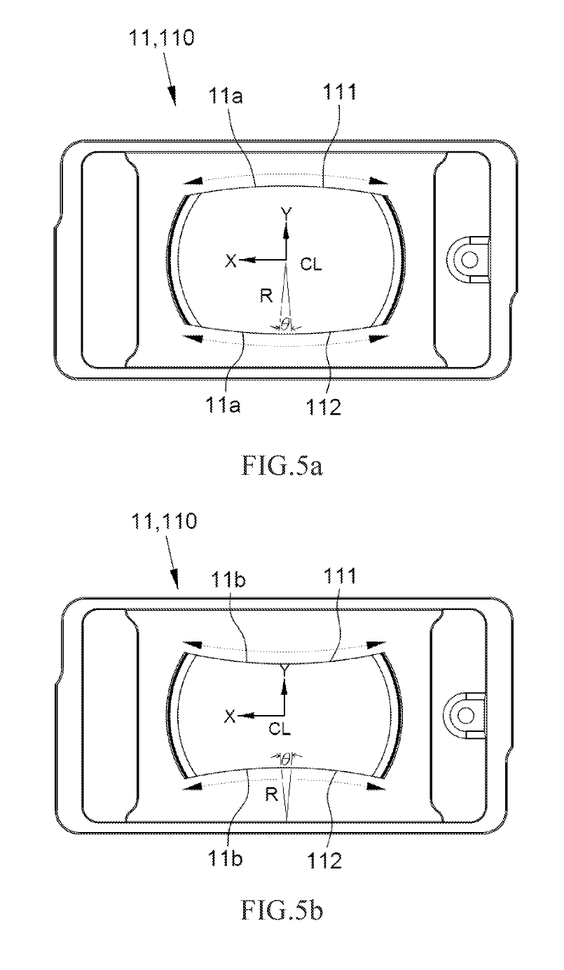

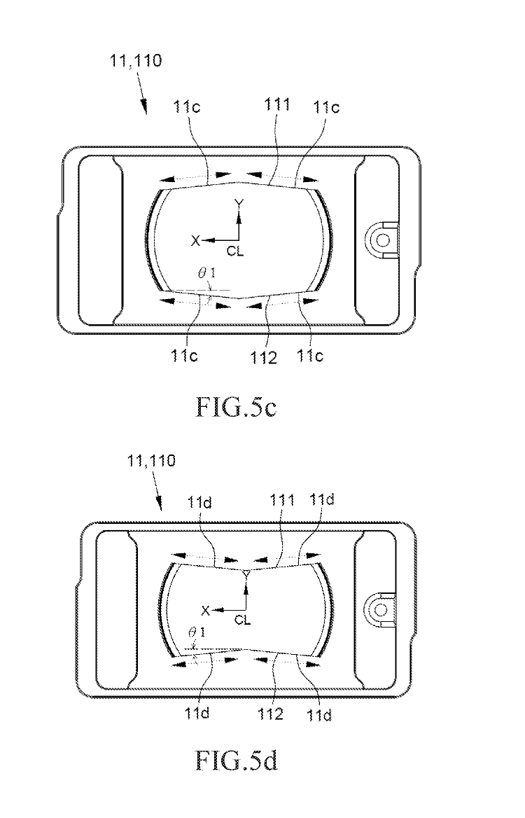

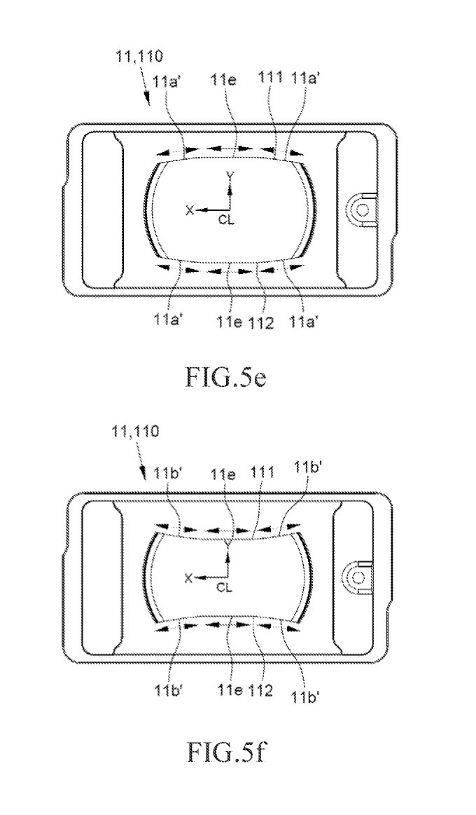

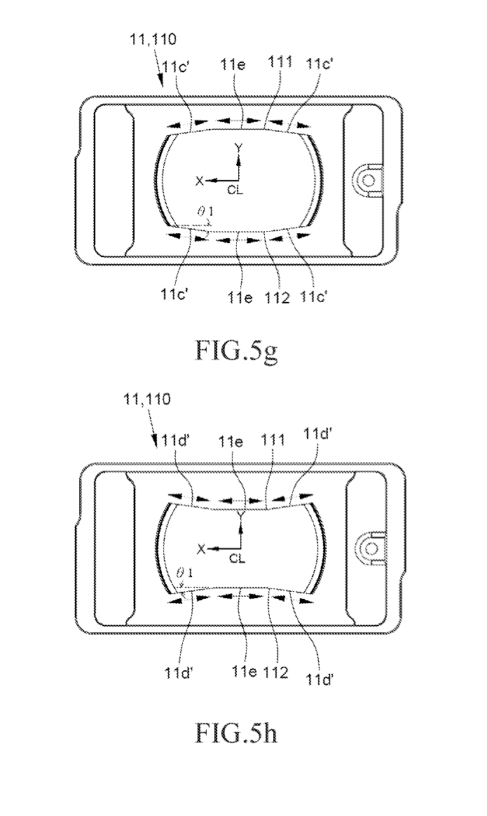

FIG. 5a is a schematic rear plan view of a lens barrel of a lens module according to the first embodiment of the present disclosure. In the plan view of the hollow barrel 110 along the central axis CL, each contour line of the first cut edge 111 and the second cut edge 112 includes: an arc line 11a that is convex outward along the Y axis. The arc line 11a can be symmetrical to the Y axis. The arc radius of the arc line 11a is R, and the following condition is satisfied: 1 mm≦R<∞. The arc central angle of the arc line 11a isθ, and the following conditions are satisfied: 1°≦θ≦90°.

FIG. 5b is a schematic rear plan view of a lens barrel of a lens module according to the second embodiment of the present disclosure. In a plan view of the hollow barrel 110 along the central axis CL, each contour line of the first cut edge 111 and the second cut edge 112 includes: an arc line 11b that is concave inward along the Y axis. The arc line 11b can be symmetrical to the Y axis. The arc radius of the arc line 11b is R, and the following condition is satisfied: 1 mm≦R<∞. The arc central angle of the arc line 11b is θ, and the following conditions are satisfied: 1°≦θ≦90°.

FIG. 5c is a schematic rear plan view of a lens barrel of a lens module according to the third embodiment of the present disclosure. In the plan view of the hollow barrel 110 along the central axis CL, each contour line of the first cut edge 111 and the second cut edge 112 includes: two oblique lines 11c that are connected and convex outward along the Y axis. The two oblique lines 11c can be symmetrical to the Y axis. The angle between the oblique line 11c and the X axis is an acute angle θ1, and the following conditions are satisfied: 0°≦θ1≦45°.

FIG. 5d is a schematic rear plan view of a lens barrel of a lens module according to the fourth embodiment of the present disclosure. In the plan view of the hollow barrel 110 along the central axis CL, each contour line of the first cut edge 111 and the second cut edge 112 includes: two oblique lines 11d that are connected and concave inward along the Y axis. The two oblique lines 11d can be symmetrical to the Y axis. The angle between the oblique line 11d and the X axis is an acute angle θ1, and the following conditions are satisfied: 0°≦θ1≦45°.

FIG. 5e is a schematic rear plan view of a lens barrel of a lens module according to the fifth embodiment of the present disclosure. In the plan view of the hollow barrel 110 along the central axis CL, each contour line of the first cut edge 111 and the second cut edge 112 includes: an arc line 11a’ that is convex outward along the Y axis. The arc line 11a’ can be symmetrical to the Y axis. Each contour line of the first cut edge 111 and the second cut edge 112 further includes a straight line 11e, the straight line 11e is parallel to the X axis, and the straight line 11e is connected between the two arc sections of the arc line 11a’. The arc radius of the arc line 11a’ is R, and the following condition is satisfied: 1 mm≦R<∞. The central angle of the arc line 11a’ is θ, and the following condition is satisfied: 1°≦θ≦90°.

FIG. 5f is a schematic rear plan view of a lens barrel of a lens module according to the sixth embodiment of the present disclosure. In the plan view of the hollow barrel 110 along the central axis CL, each contour line of the first cut edge 111 and the second cut edge 112 includes: an arc line 11b’ that are concave inward along the Y axis. The arc line 11b’ can be symmetrical to the Y axis. Each contour line of the first cut edge 111 and the second cut edge 112 further includes a straight line 11e, the straight line 11e is parallel to the X axis, and the straight line 11e is connected between the two arc sections of the arc line 11b’. The arc radius of the arc line 11b’ is R, and the following condition is satisfied: 1 mm ≦R<∞. The central angle of the arc line 11b’ is θ, and the following condition is satisfied: 1°≦θ≦90°.

FIG. 5g is a schematic rear plan view of a lens barrel of a lens module according to the seventh embodiment of the present disclosure. In the plan view of the hollow barrel 110 along the central axis CL, each contour line of the first cut edge 111 and the second cut edge 112 includes: two oblique lines 11c’ that are connected and convex outward along the Y axis. The two oblique lines 11c’ can be symmetrical to the Y axis. Each contour line of the first cut edge 111 and the second cut edge 112 further includes a straight line 11e, the straight line 11e is parallel to the X axis, and the two oblique lines 11c’ are connected through the straight line 11e. The angle between the oblique line 11c’ and the X axis is an acute angle θ1, and the following condition is satisfied: 0°≦θ1≦45°.

FIG. 5h is a schematic rear plan view of a lens barrel of a lens module according to the eighth embodiment of the present disclosure. In the plan view of the hollow barrel 110 along the central axis CL, each contour line of the first cut edge 111 and the second cut edge 112 includes: two oblique lines 11d’ that are connected and concave inward along the Y axis. The two oblique lines 11d’ can be symmetrical to the Y axis. Each contour line of the first cut edge 111 and the second cut edge 112 further includes a straight line 11e, the straight line 11e is parallel to the X axis, and the two oblique lines 11d’ are connected through the straight line 11e. The angle between the oblique line 11d’ and the X axis is an acute angle θ1, and the following condition is satisfied: 0°≦θ1≦45°.

The lens barrel of the lens module in the prior art has the conventional design of cut edges, and each contour line of the cut edges is a simple straight line. When light hits a position of the cut edges of the lens barrel (such as the lens also has corresponding cut edges), stray light is easily generated. The lens barrels of the lens modules of the above-mentioned first to eighth embodiments of the present disclosure scatter light by designing the structural cut edges (such as an arc line, two oblique lines, a combination of an arc line and a straight line, or a combination of two oblique lines and a straight line), thereby eliminating the stray light to improve an image quality of the lens module.

FIG. 5i is a schematic rear plan view of a lens barrel of a lens module according to the ninth embodiment of the present disclosure. Referring to FIG. 4 and FIG. 5i, the inner periphery 119 further includes a third cut edge 113 that is contracted along the X axis toward the center (i.e., position close to the central axis CL) of the hollow barrel 110 of the lens barrel 11. The lens of the lens module in the prior art was designed with two cut edges, which is contracted along the Y axis, and possibly has the problem of uneven assembled forces. The lens of the lens module of the above-mentioned ninth embodiment adopts a multi-directional (along the Y axis and the X axis) cut edges, so that the assembled force can be uniform, and the lens can be deformed uniformly.

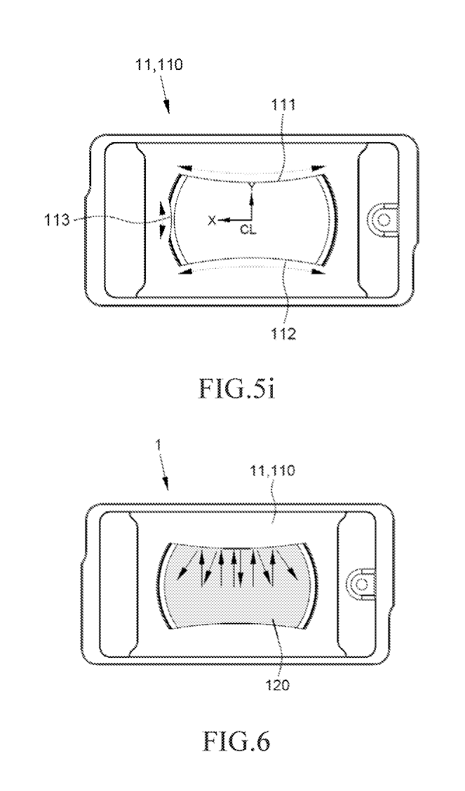

FIG. 6 is a schematic rear view of a lens barrel and a lens of a lens module according to an embodiment of the present disclosure. FIG. 6 shows the lens barrel 11 and the lens 120 of the lens module 1 in the sixth embodiment. The contour line including simple straight line causes the light to still be reflected in the same direction, and the cut edges of the lens barrel 11 (such as the lens 120 also has corresponding cut edges) have the contour line including the arc line that is concave inward along the Y axis can scatter reflected light to eliminate stray light.

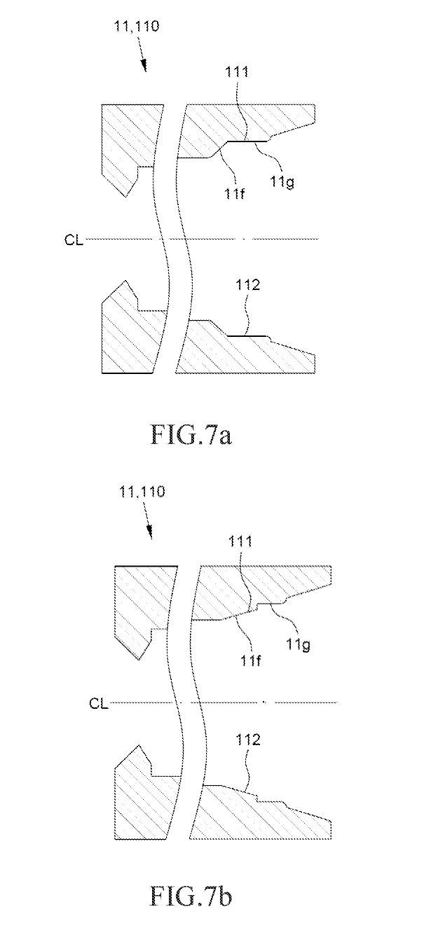

FIG. 7a is a schematic sectional view of a lens barrel of a lens module according to the tenth embodiment of the present disclosure. FIG. 7b is a schematic sectional view of a lens barrel of a lens module according to the eleventh embodiment of the present disclosure. Referring to FIG. 3 and FIG. 7a to FIG. 7b, in a sectional view of the hollow barrel 110 along the X axis the first cut edge 111 and the second cut edge 112 are selected from the group consisting of: at least one oblique plane 11f, at least one horizontal plane 11g, or a combination of at least one oblique plane 11f and at least one horizontal plane 11g.

The cut edges of the lens barrel of the lens module in the prior art is designed with of the cut edge having simple straight line or two cut edges. The cut edge having simple straight line is easy to generate stray light. The cross-section of the lens barrels in the tenth and eleventh embodiments is a multi-cut-edge design, which can simultaneously eliminate the stray light, increase alignment strength, and improve alignment accuracy. Furthermore, the cut edges of the lens barrel of the lens module in the prior art are designed without a supporting platform, and during assembly there are only non-cut-edge portion for support. The lens barrels in the above-mentioned tenth and eleventh embodiments are designed to use a supporting oblique plane or a supporting horizontal plane as a supporting platform to improve the assembly reliability of the lens.

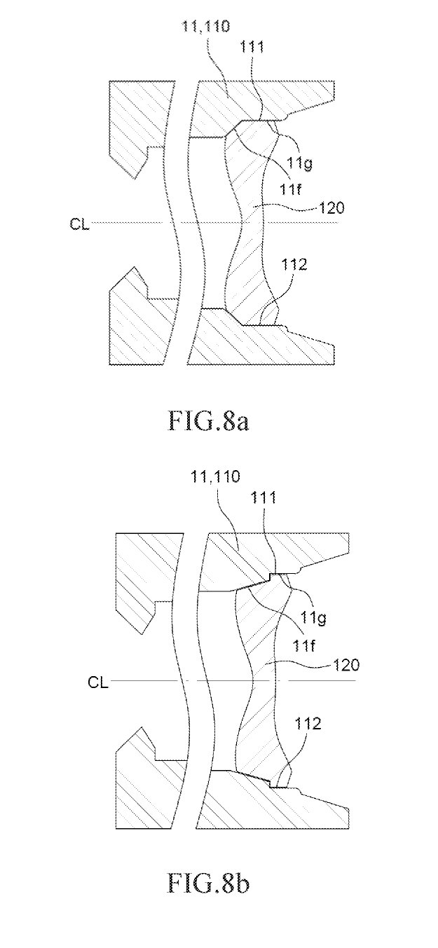

FIG. 8a and FIG. 8b are two schematic sectional views of a lens barrel and lens of a lens module according to an embodiment of the present disclosure. FIG. 8a and FIG. 8b show the lens barrel 11 in the tenth and eleventh embodiments. During assembly the lens barrel in the tenth and eleventh embodiments can improve the alignment accuracy by the multi-cut-edge design, and be designed with a supporting platform, whereby the cut-edge position of the lens barrel are supported by the lens accordingly, and the assembly reliability can be improved.

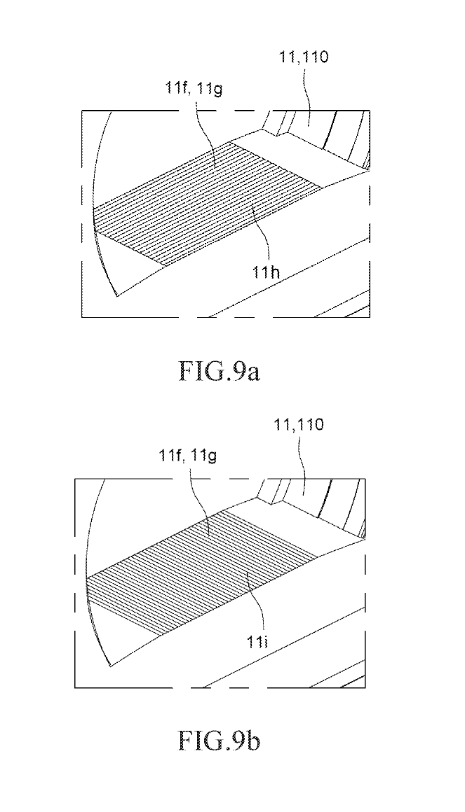

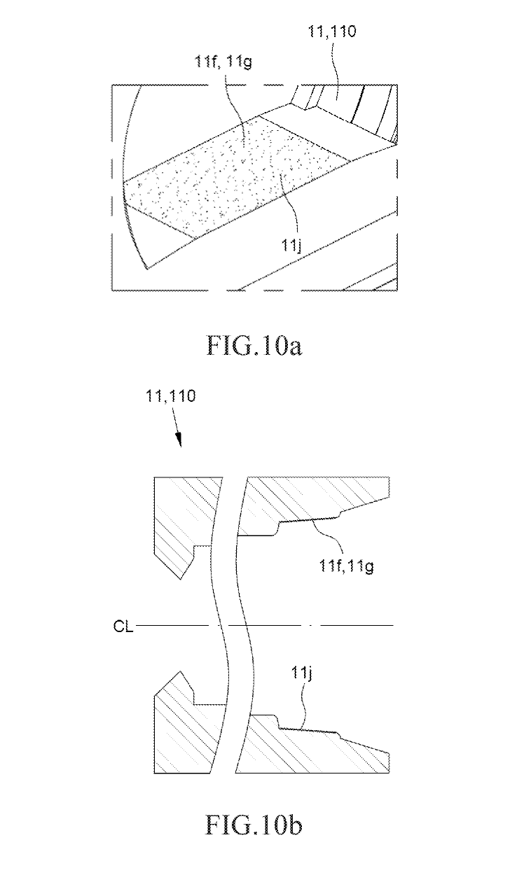

FIG. 9a is a schematic partial perspective view of a lens barrel of a lens module of the twelfth embodiment of the present disclosure. FIG. 9b is a schematic partial perspective view of a lens barrel of a lens module of the thirteenth embodiment of the present disclosure. Referring to FIG. 4 and FIG. 9a to FIG. 9b, the oblique plane 11f or the horizontal plane 11g is provided with a strip microstructure 11h (which is around the circumferential direction of the central axis CL) or a strip microstructure 11i (which is parallel to the straight direction of the central axis CL), wherein the interval between wave peaks (or between wave troughs) of the strip microstructure can be 2-10 μm, and the depth can be 0.1-0.3 μm, but is not limited thereto. FIG. 10a is a schematic partial perspective view of a lens barrel of a lens module of the fourteenth embodiment of the present disclosure. FIG. 10b is a schematic sectional view of a lens barrel of a lens module of the fourteenth embodiment of the present disclosure. The oblique plane 11f or the horizontal plane 11g is provided with a granular microstructure 11j (produced by roughening process of atomization process or sandblasting process), wherein the roughness Sa of the granular microstructure can be 0.05-3.0 μm, but is not limited thereto.

The shape of the cut edges of the lens barrel of the lens module in the prior art is a simple plane. The lens barrel of the lens module in the twelfth to fourteenth embodiments of the present invention respectively performs microstructural processing or microstructural roughening on the oblique plane or the horizontal plane of the cut edges. Both microstructural processing and microstructural roughening can scatter light, and also increase the glue’s contact area to increase the destructive strength (by push test).

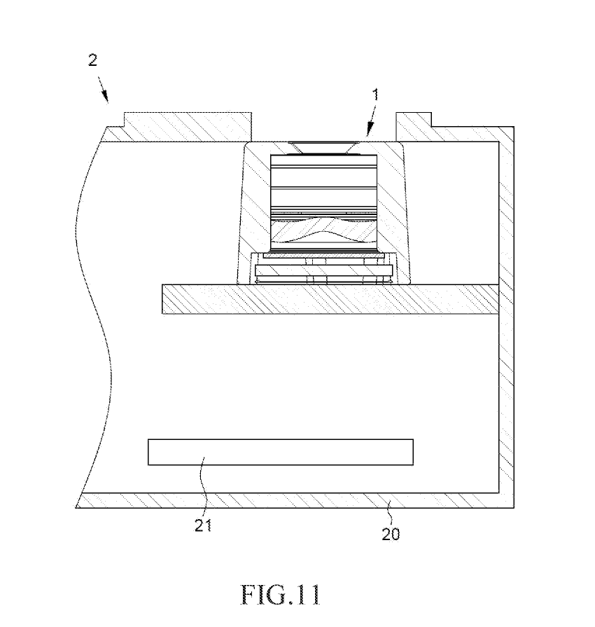

FIG. 11 is a schematic sectional view of an electronic device according to an embodiment of the present disclosure. The electronic device 2 includes: a housing 20, the lens module 1 of the present disclosure, and a control component 21. The lens module 1 is disposed in the housing 20. The control component 21 is disposed in the housing 20 and is electrically connected to the optical sensor of the lens module 1. The electronic device 2 of the present disclosure can be a mobile phone, a laptop, etc. In addition, the lens module provided by the present disclosure may be used in photography, surveillance, automation equipment, vehicle surround systems, and electronic imaging systems in the internet of things (IOT) equipment, but is not limited thereto.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. A lens module, defining a central axis, an X axis, a Y axis, an object side and an image side, wherein the central axis, the X axis and the Y axis are perpendicular to each other, and the lens module comprises:
a lens barrel having a hollow barrel; and
an optical lens assembly disposed in the lens barrel, wherein the optical lens assembly includes at least one lens; and
wherein the hollow barrel of the lens barrel comprises an inner periphery, and the inner periphery comprises first and second cut edges, which are respectively contracted toward a center of the lens along the Y axis; and
wherein in a plan view of the hollow barrel along the central axis, each contour line of the first and second cut edges includes one of the following elements of: an arc line that is convex outward along the Y axis, an arc line that is concave inward along the Y axis, two oblique lines that are connected and convex outward along the Y axis, and two oblique lines that are connected and concave inward along the Y axis.

2. The lens module according to claim 1, wherein each contour line of the first and second cut edges further includes a straight line, the straight line is parallel to the X axis and the straight line is connected between the two arc sections of the arc line.

3. The lens module according to claim 1, wherein each contour line of the first and second cut edges further includes a straight line, the straight line is parallel to the X axis and the two oblique lines are connected through the straight line.

4. The lens module according to claim 1, wherein the inner periphery further includes third cut edge, which is contracted toward the center of the lens along the X axis.

5. The lens module according to claim 1, wherein an arc radius of the arc line is R, and the following conditions are satisfied: 1 mm≦R≦∞.

6. The lens module according to claim 1, wherein the angle between the oblique line and the X axis is an acute angle θ1, and the following conditions are satisfied: 0°≦θ1 ≦45°.

7. The lens module according to claim 1, wherein in a sectional view of the hollow barrel along the X axis, the first and second cut edges are selected from the group consisting of: at least one oblique plane, at least one horizontal plane, and a combination of at least one oblique plane and at least one horizontal plane.

8. The lens module according to claim 7, wherein the oblique plane or the horizontal plane is provided with a strip microstructure, an interval between wave peaks of the strip microstructure is 2-10 μm, and a depth of the strip microstructure is 0.1-0.3 μm.

9. The lens module according to claim 7, wherein the oblique plane or the horizontal plane is provided with a granular microstructure, and a roughness Sa of the granular microstructure is 0.05-3.0 μm.

10. An electronic device, comprising:
a housing;
a lens module disposed in the housing, wherein:
the lens module defines a central axis, an X axis, a Y axis, an object side and an image side, wherein the central axis, the X axis and the Y axis are perpendicular to each other, and the lens module comprises:
a lens barrel having a hollow barrel; and
an optical lens assembly disposed in the lens barrel, wherein the optical lens assembly includes at least one lens; and
wherein the hollow barrel of the lens barrel comprises an inner periphery, and the inner periphery comprises first and second cut edges, which are respectively contracted toward a center of the lens along the Y axis; and
wherein in a plan view of the hollow barrel along the central axis, each contour line of the first and second cut edges includes one of the following elements of: an arc line that is convex outward along the Y axis, an arc line that is concave inward along the Y axis, two oblique lines that are connected and convex outward along the Y axis, and two oblique lines that are connected and concave inward along the Y axis; and
a control component disposed in the housing and electrically connected to an optical sensor of the lens module.

11. The electronic device according to claim 10, wherein each contour line of the first and second cut edges further includes a straight line, the straight line is parallel to the X axis and the straight line is connected between the two arc sections of the arc line.

12. The electronic device according to claim 10, wherein each contour line of the first and second cut edges further includes a straight line, the straight line is parallel to the X axis and the two oblique lines are connected through the straight line.

13. The electronic device according to claim 10, wherein the inner periphery further includes third cut edge, which is contracted toward the center of the lens along the X axis.

14. The electronic device according to claim 10, wherein an arc radius of the arc line is R, and the following conditions are satisfied: 1 mm≦R≦∞.

15. The electronic device according to claim 10, wherein the angle between the oblique line and the X axis is an acute angle θ1, and the following conditions are satisfied: 0°≦θ1≦45°.

16. The electronic device according to claim 10, wherein in a sectional view of the lens along the X axis, the first and second cut edges are selected from the group consisting of: at least one oblique plane, at least one horizontal plane, and a combination of at least one oblique plane and at least one horizontal plane.

17. The electronic device according to claim 16, wherein the oblique plane or the horizontal plane is provided with a strip microstructure, an interval between wave peaks of the strip microstructure is 2-10 μm, and a depth of the strip microstructure is 0.1-0.3 μm.

18. The electronic device according to claim 16, wherein the oblique plane or the horizontal plane is provided with a granular microstructure, and a roughness Sa of the granular microstructure is 0.0-05..0 μm.
